(19) United States
(12) Patent Application Publication
(10) Pub. No.: US 2026/0274027 A1
(43) Pub. Date: Sep. 17, 2026

(54) SUSPENSION DEVICE FOR GROUND ROVER MOBILITY

(71) Applicants: HYUNDAI MOTOR COMPANY, Seoul (KR); KIA CORPORATION, Seoul (KR); Inha University Research and Business Foundation, Incheon (KR)

(72) Inventors: Seungyong Chae, Hwaseong-si (KR); Dongmyung Ko, Hwaseong-si (KR); Hyeonwoo Choi, Hwaseong-si (KR); Jaeyoung Kang, Incheon (KR)

(73) Assignees: HYUNDAI MOTOR COMPANY, Seoul (KR); KIA CORPORATION, Seoul (KR); Inha University Research and Business Foundation, Incheon (KR)

(21) Appl. No.: 19/401,850

(22) Filed: Nov. 26, 2025

(30) Foreign Application Priority Data
Mar. 13, 2025 (KR) 10-2025-0032649

(51) Int. Cl. B60G 11/10; B60G 11/04; B60G 11/08; B60G 13/00; B60K 7/00; B62D 7/18; B62D 61/10

(52) U.S. Cl. CPC B60G 11/10; B60G 11/04; B60G 11/08; B60G 13/001; B60K 7/0007; B62D 7/18; B62D 61/10; B60G 2202/112; B60G 2202/114; B60G 2204/121; B60G 2204/41; B60G 2206/428; B60G 2206/73; B60G 2300/07

(57) ABSTRACT

A suspension device for a ground rover vehicle includes a pair of front wheels, a pair of center wheels, and a pair of rear wheels provided on a vehicle body. The suspension device includes main leaf springs disposed along a forward-backward direction of the vehicle body on both sides along a vehicle width direction of the vehicle body, the main leaf springs being pivotally connected to lower sides of the vehicle body, and to which the front wheels and the center wheels are connected. The suspension device further includes a sub-leaf spring disposed along the vehicle width direction at a rear of the mobility body, fixed to a rear lower part of the vehicle body, and to which the pair of rear wheels are connected.

### CROSS-REFERENCE TO RELATED APPLICATION

This application claims priority to and the benefit of Korean Patent Application No. 10-2025-0032649 filed with the Korean Intellectual Property Office on Mar. 13, 2025, the entire contents of which are incorporated herein by reference.

### BACKGROUND

### Technical Field

Disclosed embodiments relate to ground rover mobility, and more particularly, the present disclosure relates to a suspension device for ground rover mobility that is configured to attenuate vibration generated when a ground rover mobility device or vehicle travels over extreme terrains such as rough terrain sections.

### Description of the Related Art

The vehicle industry has been introducing new-concept future mobility visions. One of these future mobility solutions is ground rover mobility, such as a ground rover vehicle or device.

Ground rover mobility involves a vehicle that may travel over terrain that is difficult for humans to access, or travel over the terrain of planets such as the Moon or Mars while exploring the geological environment of the planet.

The ground rover vehicle may move along the surface of the ground in an unmanned autonomous driving manner. For example, the ground rover vehicle may include a mobility body (e.g., vehicle body) and wheels that are mounted to the mobility body.

The wheels may be drivable by a drive motor (for example, an in-wheel motor), and may be provided to be steerable by a steering motor.

Such ground rover vehicles may be exposed to driving circumstances of rough sections in which obstacles having severe protrusions and depressions are scattered. Therefore, related research for improving the mobility and stability of ground rover vehicles under such extreme driving circumstances is being variously conducted.

The matters described in the Background section have been prepared to enhance the understanding of the background, and may include matters that are not prior art already known to those having ordinary skill in the art to which this technology pertains.

### SUMMARY

Disclosed embodiments provide a suspension device for ground rover mobility, which may secure driving stability of a ground rover vehicle in driving circumstances of a rough section, and may effectively attenuate vibration of a mobility vehicle body and wheels.

A suspension device for a ground rover vehicle according to disclosed embodiments may include a pair of front wheels, a pair of center wheels, and a pair of rear wheels provided on a vehicle body. The suspension device according to disclosed embodiments may include main leaf springs disposed along the forward-backward direction of the vehicle body on both sides along the vehicle width direction of the vehicle body, pivotally connected to the lower sides of the vehicle body, and to which the pair of front wheels and the pair of center wheels are connected, and a sub-leaf spring disposed along the vehicle width direction at the rear of the vehicle body, fixed to the rear lower part of the vehicle body, and to which the pair of rear wheels are connected.

The suspension device according to disclosed embodiments may further include a main damper connecting the main leaf springs and the vehicle body, and a sub-damper connected to both sides of the sub-leaf spring and the vehicle body.

The suspension device according to disclosed embodiments may further include a pivot bush joint that is mounted on each of the main leaf springs and engages the vehicle body.

Each of the main leaf springs may be shaped as “U”, and the sub-leaf spring may be straight.

Each of the main leaf springs may include a straight portion formed along a forward-backward direction of the vehicle body, and a front bent portion and a rear bent portion extending outwardly from the front and rear ends of the straight portion toward the edge of the vehicle body along the vehicle width direction, respectively.

A pivot bush joint capable of engaging the vehicle body may be mounted on the straight portion, a front wheel of the pair of front wheels may be installed on the front bent portion, and a center wheel of the pair of center wheels may be installed on the rear bent portion.

The sub-leaf spring may include a straight leaf spring fixed to a spring mount portion provided on the vehicle body.

The pair of rear wheels may be installed at both ends of the straight leaf springs, which extend outward from the edge of the vehicle body along the vehicle width direction.

The suspension device according to disclosed embodiments may further include a front steering knuckle assembly rotatably connected to the front bent portion, a fixed knuckle assembly fixed to the rear bent portion, and a rear steering knuckle assembly rotatably connected to both ends of the sub-leaf spring.

The suspension device according to disclosed embodiments may further include a front steering actuator connected to the front steering knuckle assembly, and a rear steering actuator connected to the rear steering knuckle assembly.

The pair of front wheels include mounted in-wheel motors and each may be installed on the front steering knuckle assembly, the pair of center wheels may be installed on each of the fixed knuckle assembly, and the pair of rear wheels include mounted in-wheel motors and may be installed on the rear steering knuckle assembly.

The front steering knuckle assembly may include a front steering knuckle body, a front steering shaft provided on the front steering knuckle body and rotatably connected to the front bent portion, and front bearings connected to an upper part and a lower part of the front steering shaft with the front bent portion in between.

The rear steering knuckle assembly may include a rear steering knuckle body, a rear steering shaft provided on the rear steering knuckle body and rotatably connected to both ends of the sub-leaf spring, and rear bearings connected to an upper part and a lower part of the rear steering shaft with the the sub-leaf spring in between.

The main damper may include a main shock absorber hinge-connected to a damper bracket mounted on the main leaf springs and hinge-connected to a damper bracket mounted on the vehicle body.

The sub-damper may include a sub-shock absorber hinge-connected to a damper bracket mounted on both sides of the sub-leaf spring and hinge-connected to a damper bracket mounted on the vehicle body.

The main leaf springs and the sub-leaf springs may be made of plastic composite material or metal material.

According to the suspension device for the ground rover vehicle according to the disclosed embodiments, it is possible to secure the driving stability of the ground rover vehicle, and effectively attenuate vibration generated during driving of a rough section.

Other effects that may be obtained or predicted due to the disclosed embodiments are to be directly or implicitly disclosed in the detailed description of the disclosed embodiments. In other words, various effects anticipated according to the disclosed embodiments are disclosed in the detailed description described below.

### BRIEF DESCRIPTION OF THE DRAWINGS

The drawings are provided for reference in explaining the disclosed embodiments, and therefore, the technical spirit of the present disclosure should not be construed as being limited to the accompanying drawings.

FIG. 1 is a top plan view illustrating a suspension device for ground rover mobility according to an embodiment.

FIG. 2 is a side view illustrating a suspension device for ground rover mobility according to an embodiment.

FIG. 3 is a rear view illustrating a suspension device for ground rover mobility according to an embodiment.

FIG. 4 is an exploded perspective view illustrating a suspension device for ground rover mobility according to an embodiment.

FIG. 5 is a drawing illustrating a connection structure of a main plate spring and a vehicle body applied to a suspension device for ground rover mobility according to an embodiment.

FIG. 6 is a drawing illustrating a connection structure of a sub plate spring and a vehicle body applied to a suspension device for ground rover mobility according to an embodiment.

FIG. 7 is a drawing illustrating a connection structure of a main damper and a vehicle body applied to a suspension device for ground rover mobility according to an embodiment.

FIG. 8 is a drawing illustrating a connection structure of a sub damper and a vehicle body to be applied to a suspension device for ground rover mobility according to an embodiment.

FIGS. 9 and 10 are drawings for explaining the operation of the suspension device for ground rover mobility according to an embodiment.

### DESCRIPTION OF SYMBOLS

11: mobility vehicle body
13: front wheel
14, 18: in-wheel motor
15: center wheel
17: rear wheel
19a: mounting protrusion portion
19b: spring mount portion
20: main leaf spring
21: straight portion
23: front bent portion
25: rear bent portion
27: front steering knuckle assembly
29: front steering actuator
29a, 55a: servo motor
31, 57: gear
33: front steering knuckle body
35: front steering shaft
37: front bearing
38, 42b, 62: nut
39: fixed knuckle assembly
39a, 51a: fastening member
40: pivot bush joint
41: joint bracket
42a: bolt
43: inner pipe
45: rubber bushing
50: sub-leaf spring
51: straight leaf spring
53: rear steering knuckle assembly
55: rear steering actuator
59: rear steering knuckle body
61: rear steering shaft
63: rear bearing
70: main damper
71: main shock absorber
73, 77, 93, 97: damper bracket
75, 95: hinge pin
90: sub-damper
91: sub-shock absorber
100: suspension device for ground rover mobility

The drawings referenced above may not necessarily be depicted to scale, and it should be understood that the drawings present somewhat simplified representations of various features illustrative of the basic principles of the disclosed embodiments. For example, specific design features of the disclosed embodiments including specific dimensions, directions, positions, and shapes may be determined in part by certain intended applications and use environments.

### DETAILED DESCRIPTION OF THE EMBODIMENTS

Hereinafter, the disclosed embodiments are described in detail with reference to the accompanying drawing so that a person having ordinary skill in the art may easily carry out the disclosure. However, the disclosed embodiments may be implemented in various different forms and are not limited to the embodiment described herein.

In order to clearly explain the disclosed embodiments, portions having no relationship with the description are omitted, and like reference numerals designate like elements throughout the specification.

Also, the size and thickness of each component shown in the drawings may be arbitrarily illustrated for better understanding and ease of description, and thus the disclosed embodiments are not necessarily limited to the aspects illustrated in the drawings. The thickness may be enlarged to clearly depict various portions and regions.

The terms used in this specification are for the purpose of describing the disclosed embodiments, and are not intended to limit the disclosed embodiments. As used in the present specification, the singular form is intended to include the plural form unless the context clearly indicates otherwise.

As used herein, a rover vehicle moves in a space related to the ground, underground, air, space, sea, and/or underwater, depending on the space in which the vehicle moves. A rover vehicle on the ground or underground may be provided in the form of, for example, vehicles, robots, etc., and a rover vehicle in the air or space, as aerial mobility devices, may be provided in the form of, for example, typical fixed-wing or rotary-wing aircraft, advanced aerial mobility device (AAM), which has been actively developed recently, unmanned aerial vehicles or drones, rockets, and units of transportation mounted on artificial satellites. A maritime or underwater rover vehicle may be, for example, a ship, a submarine, or the like. The rover vehicle is not limited to a specific space and may be a mobile body that may move through all of the aforementioned spaces, that is, a mobile body that may move between multiple spaces, and may be, for example, an amphibious vehicle, a flying vehicle, and the like.

In this specification, the terms ‘includes’ and/or ‘including’ as used herein indicate the presence of the stated features, numerals, steps, operations, elements and/or components, but it is also to be understood that these terms do not preclude the presence or addition of one or more other features, numerals, steps, operations, components, and/or groups thereof.

Also, as used in this specification, the terms ‘connected’ or ‘coupled’ denote a physical relationship between two components, wherein the components may be directly connected to each other or may be indirectly connected through one or more intermediate components.

Also, in this specification, the term ‘operably connected’ or similar terms means that at least two members are directly or indirectly connected to each other so that power may be transferred. However, two members operationally connected do not always rotate at the same speed and in the same direction.

When a component, controller, device, element, apparatus, module, unit or the like of the present disclosure is described as having a purpose or performing an operation, function, or the like, the component, controller, device, element, apparatus, module, unit or the like should be considered herein as being “configured to” meet that purpose or to perform that operation or function. Each component, unit, controller, device, element, apparatus, module, and the like may separately embody or be included with a processor and a memory, such as a non-transitory computer readable media, as part of the apparatus.

Hereinafter, the disclosed embodiments are described in detail with reference to the accompanying drawing.

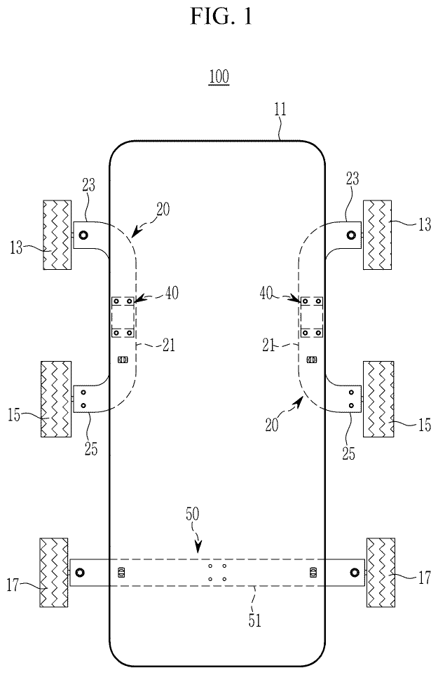

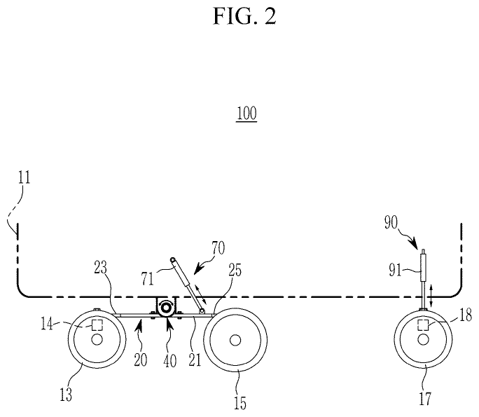

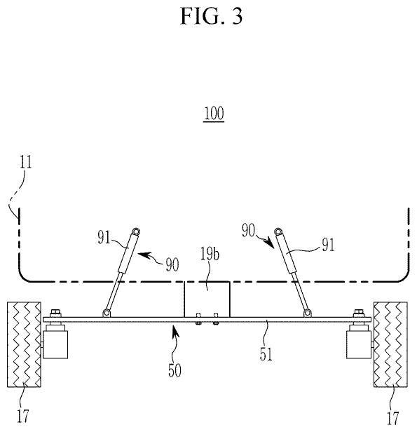

FIG. 1 is a top plan view illustrating a suspension device for ground rover mobility according to the disclosed embodiment, FIG. 2 is a side view illustrating a suspension device for ground rover mobility according to the disclosed embodiment, and FIG. 3 is a rear view illustrating a suspension device for ground rover mobility according to the disclosed embodiment.

Referring to FIGS. 1-3, a suspension device 100 for ground rover mobility according to the disclosed embodiment may be applied to, for example, a ground rover vehicle of a 6-wheel rocker-bogie type.

The ground rover vehicle is applying a driving mechanism that travels not only on flat terrain but also in areas of terrain or facility zones that are difficult for a person to access, in an autonomous driving manner.

Such ground rover vehicles may be, for example, a logistics delivery vehicle for transporting goods, or an inspection vehicle equipped with inspection equipment for equipment inspection. Further, the ground rover vehicle may be an exploration vehicle that may explore the geological environment of a planet while traveling over the terrain of a planet such as the Moon or Mars.

In this specification, the reference direction for describing the following components may be set as the forward-backward direction of the vehicle body (for example, the vehicle body length direction or longitudinal direction), the vehicle width direction (for example, the left-right direction or transverse direction), and the vertical direction (for example, the height direction), when reference is made to the drawings.

Furthermore, in the present specification, the ‘upper end portion’, ‘upper portion’, ‘upper end’, or ‘upper surface’ of a component refers to the end portion, or surface of the component that is relatively positioned at the upper side in the drawing, and the ‘lower end portion’, ‘lower portion’, ‘lower end’, or ‘bottom surface’ of a component refers to the end portion, or surface of the component that is relatively positioned at the lower side in the drawing.

Further, in the present specification, the end (e.g., one end or the other end) of a component indicates the edge of the component in any one direction, and the end portion (e.g., one end portion or the other end portion) of the component refers to a certain portion of the component including the end.

The ground rover vehicle as described above may include a mobility or vehicle body 11, and a plurality of wheels (e.g., a plurality of pairs of wheels) 13, 15, and 17 mounted on the vehicle body 11.

The front wheels 13, center wheels 15, and rear wheels 17 may, for example, be driven or driving wheels driven by a motor. Also, as another example, the front wheels 13 and the rear wheels 17 may be driven wheels, and the center wheels 15 may be non-driven wheels.

For convenience of understanding, examples are described in which the front wheels 13 and the rear wheels 17 are applied as driving wheels, and the center wheels 15 are applied as non-driven wheels. However, the driving and driven methods of the wheels 13, 15, and 17 may be selectively determined according to the type of vehicle or the like, but are not limited thereto.

Further, in another example, the front wheels 13 and the rear wheels 17 may be provided to be steerable in the yaw direction by driving of the motor.

According to the disclosed embodiments, the suspension device 100 for ground rover mobility may implement driving stability and low ground clearance of the ground rover vehicle in driving circumstances of a rough section in which obstacles having severe protrusions and depressions are scattered, and may provide a structure capable of effectively attenuating vibration of the vehicle body 11 and the wheels 13, 15, and 17.

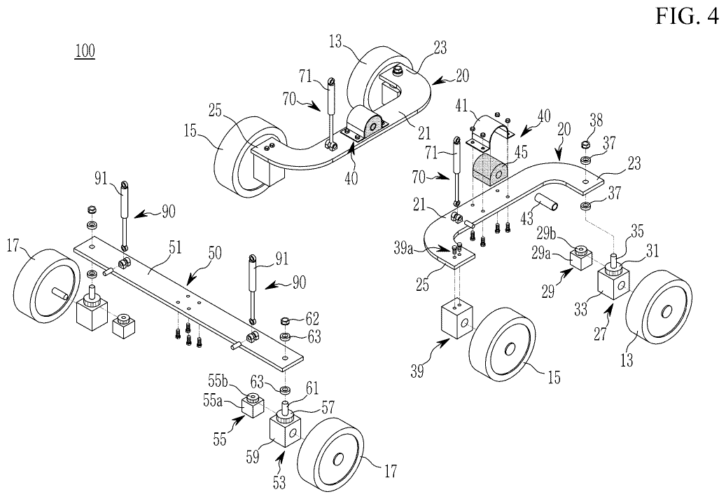

FIG. 4 is an exploded perspective view illustrating a suspension device for ground rover mobility according to an embodiment.

Referring to FIGS. 1-4, the suspension device 100 for ground rover mobility according to an embodiment disclosed may include main leaf springs (or flat spring, plate spring) 20, a pivot bush joint 40, a sub-leaf spring (or flat spring, plate spring) 50, main dampers 70, and sub-dampers 90.

In the disclosed embodiments, the main leaf springs (or flat spring, plate spring) 20 may be arranged along the forward-backward direction of the vehicle body 11 on both sides along the vehicle width direction of the vehicle body 11, respectively.

The main leaf springs 20 may be pivotally connected to the lower sides of the vehicle body 11, respectively. The main leaf springs 20 may be equipped with pivot arms. The main leaf springs 20 may be connected to the front wheels 13 and the center wheels 15.

The main leaf springs 20 may be made of an elastically deformable material, such as a plastic composite material or a metal material, to attenuate vibrations of the vehicle body 11 and the front wheels 13 and center wheels 15.

The plastic composite material may be, for example, glass fiber reinforced plastic (GFRP: Glass Fiber Reinforced Plastic), and the metal material may be, for example, steel.

Each of the main leaf springs 20 may be arranged in a ‘U’ shape. Each of the main leaf springs 20 may include a straight portion 21, a front bent portion 23, and a rear bent portion 25.

The straight portion 21 is formed along the forward-backward direction of the vehicle body 11. The front bent portion 23 extends in a curved manner from the front end of the straight portion 21 outwardly toward the edge of the vehicle body 11 along the vehicle width direction. The rear bent portion 25 extends in a curved manner from the rear end of the straight portion 21 outwardly toward the edge of the vehicle body 11 along the vehicle width direction.

The front wheels 13 have wheel motors 14 mounted thereon and may be mounted to the front bent portion 23.

A front steering knuckle assembly 27 may be rotatably connected to the bottom surface of the front bent portion 23. The front wheels 13 may be installed on the front steering knuckle assembly 27.

The front steering knuckle assembly 27 may be operationally connected to a front steering actuator 29 fixed to the bottom surface of the front bent portion 23. The front steering knuckle assembly 27 may be rotated by the operation of the front steering actuator 29. For example, the front steering knuckle assembly 27 may implement steering operation through yaw direction rotation by the operation of the front steering actuator 29.

The front steering actuator 29 may, in one example, include a servo motor 29a capable of servo control of the rotating direction and rotation speed.

The front steering knuckle assembly 27 may be connected to the front steering actuator 29 via a gear 31. The gear 31 may engage a drive gear 29b connected to the motor shaft (not shown) of the servo motor 29a. The gear connection structure of the front steering knuckle assembly 27 and the front steering actuator 29 should be understood by those having ordinary skill in the art, and thus, a detailed description thereof has been omitted.

When the front steering knuckle assembly 27 rotates by the operation of the front steering actuator 29, steering of the front wheels 13 driven by the operation of the in-wheel motor 14 may be implemented.

The front steering knuckle assembly 27 may include a front steering knuckle body 33, a front steering shaft 35, and a pair of front bearings 37.

The front steering knuckle body 33 may be formed in a block shape, and the front wheels 13 may be installed on the front steering knuckle body 33.

The front steering shaft 35 is provided along the vertical direction in the front steering knuckle body 33 and may be rotatably connected to the front bent portion 23.

The front bearings 37 may be connected to the upper and lower parts of the front steering shaft 35 via the front bent portion 23. A fastener 38 may be engaged at the upper end of the front steering shaft 35. For example, the fastener 38 may include a nut.

The rear bent portion 25 may be equipped with the center wheels 15. The drawing shows the center wheels 15 as driven wheels without an in-wheel motor mounted on them, but this is not a limitation. An in-wheel motor may also be mounted on the center wheels 15.

To install the center wheels 15 on the rear bent portion 25, a fixed knuckle assembly 39 may be fixed to the bottom surface of the rear bent portion 25.

The fixed knuckle assembly 39 may be connected to the rear bent portion 25 by a fastening member 39a. For example, fastening member 39a may include a bolt and a nut. The center wheels 15 may be rotatably installed to the fixed knuckle assembly 39.

In the disclosed embodiments, the pivot bush joint 40 is configured to pivotally connect the main leaf springs 20 to the lower sides of the vehicle body 11.

The pivot bush joint 40 is mounted on the upper surface of the straight portion 21 of the main leaf springs 20 and may engage the vehicle body 11.

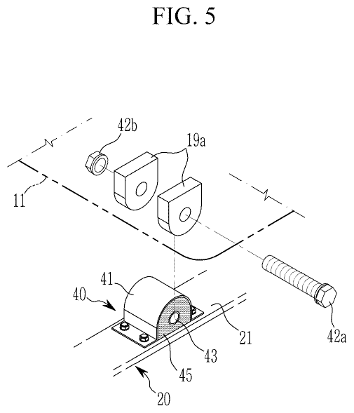

FIG. 5 is a drawing illustrating a connection structure of a main plate spring and a vehicle body applied to a suspension device for ground rover mobility according to an embodiment.

The pivot bush joint 40 may include a joint bracket 41 connected to the upper surface of the straight portion 21, an inner pipe 43 connected along the vehicle width direction on the inner side of the joint bracket 41, and a rubber bush or bushing 45 bonded to the inner side of the joint bracket 41 and the exterior circumference of the inner pipe 43 as shown in FIG. 4 and FIG. 5.

The joint bracket 41 may be disposed between a pair of mounting protrusion portions 19a protruding downward from the lower sides of the vehicle body 11. The joint bracket 41 may be connected to the mounting protrusion portions 19a via the inner pipe 43 by means of fasteners. For example, the joint bracket 41 may be connected to the mounting protrusion portions 19a by means of bolt 42a and nut 42b. The bolt 42a may be engaged with the nut 42b by passing through the mounting protrusion portions 19a and the inner pipe 43.

The main leaf springs 20 according to the disclosed embodiments may be pivotally connected to the lower sides of the vehicle body 11 by the pivot bush joints 40.

Referring to FIGS. 1-4, in the disclosed embodiments, the sub-leaf spring (or flat spring, plate spring) 50 may be disposed along the vehicle width direction at the rear of the vehicle body 11.

The sub-leaf spring 50 may be fixed to the rear lower part of the vehicle body 11. The sub-leaf spring 50 may be connected to the rear wheels 17.

The sub-leaf spring 50 may be made of an elastically deformable material, such as a plastic composite material or a metal material, to attenuate vibrations of the vehicle body 11 and the rear wheels 17.

The plastic composite material may be, for example, glass fiber reinforced plastic (GFRP: Glass Fiber Reinforced Plastic), and the metal material may be, for example, steel.

The sub-leaf spring 50 may be provided in a straight shape. The sub-leaf spring 50 may include a straight leaf spring (or flat spring) 51.

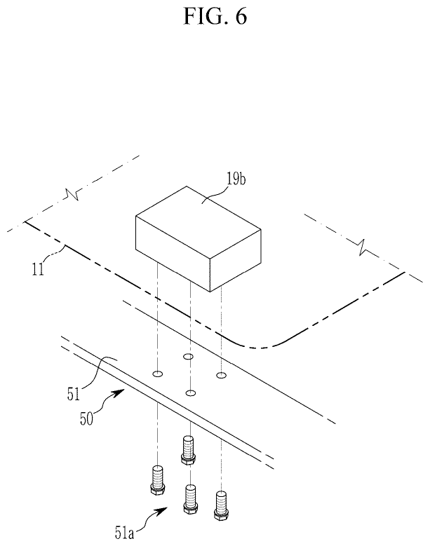

FIG. 6 is a drawing illustrating a connection structure of a sub plate spring and a vehicle body applied to a suspension device for ground rover mobility according to an embodiment.

As shown in FIG. 6, the straight leaf spring 51 may be fixed to the spring mount portion 19b provided at the rear lower portion of the vehicle body 11.

The straight leaf spring 51 may be connected to the spring mount portion 19b by a fastening member 51a, for example a bolt.

Both ends of the straight leaf spring 51 may extend outward from the edge of the vehicle body 11 along the vehicle width direction.

The rear wheels 17 with in-wheel motors 18 mounted thereon may be mounted on both ends of the straight leaf spring 51.

A rear steering knuckle assembly 53 may be rotatably connected to the bottom surface of both ends of the straight leaf spring 51. The rear wheels 17 may be installed on the rear steering knuckle assembly 53.

The rear steering knuckle assembly 53 may be operationally connected to a rear steering actuator 55 fixed to the bottom surface of both ends of the straight leaf spring 51. The rear steering knuckle assembly 53 may be rotated by the operation of the rear steering actuator 55.

The rear steering actuator 55 may include, for example, a servo motor 55a capable of servo control of the rotating direction and rotation speed.

The rear steering knuckle assembly 53 may be connected to the rear steering actuator 55 via a gear 57. The gear 57 may engage with a drive gear 55b connected to the motor shaft (not shown) of the servo motor 55a. The gear connection structure of the rear steering knuckle assembly 53 and the rear steering actuator 55 should be understood by those having ordinary skill in the art, so a detailed description is omitted.

When the rear steering knuckle assembly 53 rotates by the operation of the rear steering actuator 55, steering of the rear wheels 17 driven by the operation of the in-wheel motor 18 may be implemented.

The rear steering knuckle assembly 53 may include a rear steering knuckle body 59, a rear steering shaft 61, and a pair of rear bearings 63.

The rear steering knuckle body 59 is provided in block form, and the rear wheels 17 may be installed on the rear steering knuckle body 59.

The rear steering shaft 61 is provided along the vertical direction on the rear steering knuckle body 59 and may be rotatably connected to both ends of the straight leaf spring 51.

The rear bearings 63 may be connected to the upper and lower parts of the rear steering shaft 61 with the ends of the straight leaf spring 51 in between. At the upper end of the rear steering shaft 61, a fastener 62, for example a nut, may be engaged.

In the disclosed embodiments, a main damper 70 is configured to absorb vibration and impact energy applied to the vehicle body 11, the front wheels 13 and the center wheels 15 when the ground rover vehicle is driven on a rough terrain section.

The main damper 70 may be connected to the main leaf springs 20. In the drawings, the main damper 70 is shown as connecting the rear portion of the main leaf spring 20, i.e., the rear portion of the straight portion 21, and the vehicle body 11 respectively, but this is not limited thereto.

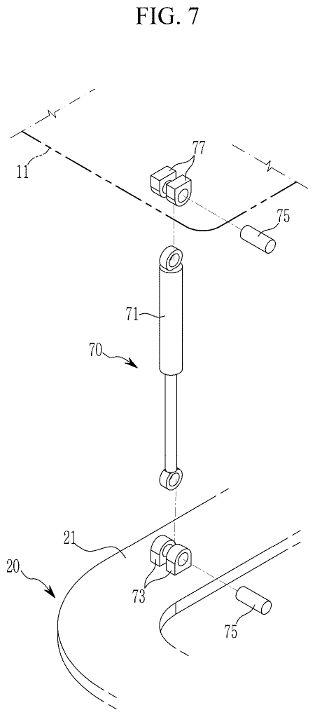

FIG. 7 is a drawing illustrating a connection structure of a main damper and a vehicle body applied to a suspension device for ground rover mobility according to an embodiment.

The main damper 70 may include the main shock absorber 71. The main shock absorber 71 is hinge-connected to a damper bracket 73 mounted on the rear of the straight portion 21, as shown in FIG. 7, via a hinge pin 75, and may be hinge-connected to a damper bracket 77 mounted on the vehicle body 11, via a hinge pin 75.

The main shock absorber 71 may be, for example, a hydraulic pressure or pneumatic shock absorber, or a spring type shock absorber.

In the disclosed embodiments, a sub-damper 90 is configured to absorb vibration and impact energy applied to the vehicle body 11 and the rear wheels 17 when the ground rover vehicle is driven on a rough terrain section.

The sub-damper 90 may connect both sides of the sub-leaf spring 50 and the vehicle body 11, respectively.

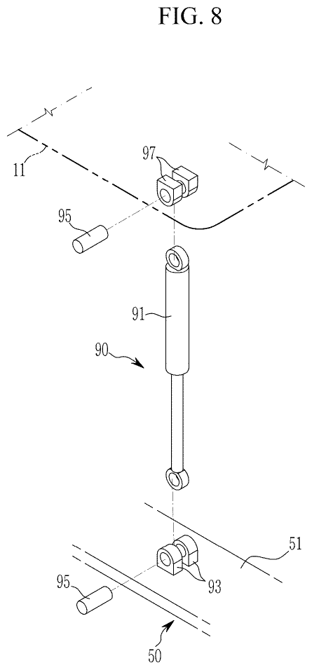

FIG. 8 is a drawing illustrating a connection structure of a sub damper and a vehicle body to be applied to a suspension device for ground rover mobility according to an embodiment.

The sub-damper 90 may include a sub-shock absorber 91. The sub-shock absorber 91, as shown in FIG. 8, is hinge-connected to a damper bracket 93 mounted on both sides of the sub-leaf spring 50 via a hinge pin 95, and may be hinge-connected to a damper bracket 97 mounted on the vehicle body 11 via a hinge pin 95.

The sub-shock absorber 91 may be, for example, a hydraulic pressure or pneumatic shock absorber, or a spring type shock absorber.

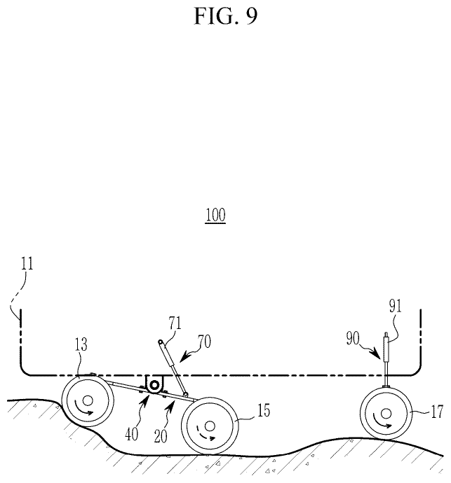

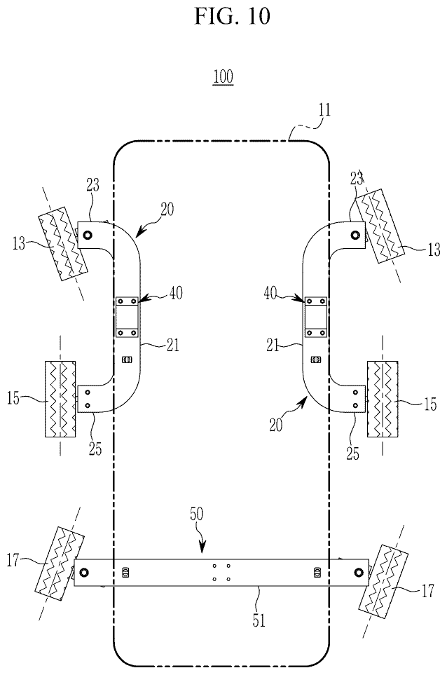

FIGS. 9 and 10 are drawings for explaining the operation of the suspension device for ground rover mobility according to an embodiment.

Hereinafter, the operation of the suspension device for ground rover mobility 100 is described in detail with reference FIGS. 1-10.

In the disclosed embodiments, the main leaf springs 20 are pivotally connected to the lower sides of the vehicle body 11 along the forward-backward direction of the vehicle body by the pivot bush joints 40. The main damper 70 is connected to the main leaf springs 20 and the vehicle body 11.

The front bent portion 23 and the rear bent portion 25 of the main leaf springs 20 extend outwardly from the front and rear ends of the straight portion 21 along the vehicle width direction toward the edge of the vehicle body 11.

The front bent portion 23 has the front steering knuckle assembly 27 rotatably connected by the operation of the front steering actuator 29. The front steering knuckle assembly 27 has the front wheels 13 with in-wheel motors 14 mounted on them.

The fixed knuckle assembly 39 is fixed to the rear bent portion 25. The fixed knuckle assembly 39 has the center wheels 15 rotatably installed.

The straight leaf spring 51 of the sub-leaf spring 50 is fixed along the vehicle width direction at the rear lower portion of the vehicle body 11. The sub-damper 90 is connected to both sides of the straight leaf spring 51 and the vehicle body 11.

The two ends of the straight leaf spring 51 extend outward from the edge of the vehicle body 11 along the vehicle width direction.

At both ends of the straight leaf spring 51, the rear steering knuckle assembly 53 is rotatably connected by the operation of the rear steering actuator 55. The rear steering knuckle assembly 53 has the rear wheels 17 with the in-wheel motors 18 mounted on them.

When the front wheels 13 and rear wheels 17 are driven and rotate, the center wheels 15 are driven and rotate, and the ground rover vehicle is driven along a predetermined driving path by the controller (not shown).

The front steering knuckle assembly 27 is rotated by the operation of the front steering actuator 29, and steering of the front wheels 13 may be implemented. The rear steering knuckle assembly 53 is rotated by the operation of the rear steering actuator 55, and steering of the rear wheels 17 may be implemented.

The ground rover vehicle may drive straight along the driving path or make turns by the front wheels 13, the center wheels 15 and the rear wheels 17.

As shown in FIG. 9, when the ground rover vehicle travels on a rough terrain, the main leaf springs 20 pivot and rotate due to the difference in the height of the front wheels 13 and the center wheels 15, and bending deformation of the main leaf springs 20 may occur. The difference in height between the rear wheels 17 may cause bending deformation of the sub-leaf spring 50.

Therefore, the deformation energy of the main leaf springs 20 and the sub-leaf springs 50 may be applied complementarily to the front wheels 13, the center wheels 15 and the rear wheels 17.

The suspension device for ground rover mobility 100 according to the disclosed embodiments may improve the ground force of the front wheels 13, the center wheels 15, and the rear wheels 17, thereby ensuring the driving stability of the ground rover vehicle.

The front steering knuckle assembly 27 is mounted on the front bent portion 23 of the main leaf springs 20, and the rear steering knuckle assembly 53 is mounted on both ends of the sub-leaf springs 50.

The suspension device for ground rover mobility 100 according to the disclosed embodiments may avoid interference between peripheral components and the front wheels 13 and the rear wheels 17 when steering the front wheels 13 and the rear wheels 17 by rotation of the front steering knuckle assembly 27 and the rear steering knuckle assembly 53.

The suspension device for ground rover mobility 100 according to the disclosed embodiments may secure steering stability of the front wheels 13 and the rear wheels 17 and implement low ground clearance of ground rover mobility.

The front bent portion 23 and the rear bent portion 25 of the main leaf springs 20, and both ends of the sub-leaf springs 50 extend outward from the edge of the vehicle body 11 along the vehicle width direction.

As shown in FIG. 10, when the ground rover vehicle turns, a negative camber angle may occur in the front wheels 13, the center wheels 15, and the rear wheels 17 due to the effect of the moment arm.

The suspension device for ground rover mobility 100 according to the disclosed embodiments may increase the outer wheel ground force of the front wheels 13, the center wheels 15, and the rear wheels 17, and secure the turning stability of the ground rover vehicle.

When the ground rover vehicle travels on rough terrain, the main leaf springs 20 and the sub-leaf springs 50 may attenuate the vibration of the vehicle body 11, the front wheels 13, the center wheels 15 and the rear wheels 17.

When the ground rover vehicle is driving on rough terrain, the main damper 70 and the sub-damper 90 may absorb vibration and impact energy applied to the vehicle body 11, the front wheels 13, the center wheels 15 and the rear wheels 17.

Therefore, the suspension device for ground rover mobility 100 according to the disclosed embodiments may prevent durability deterioration of the ground rover vehicle due to rough terrain driving of the ground rover vehicle.

Although the disclosed embodiments have been described above, the disclosed embodiments may be implemented in various modifications within the scope of the claims, the detailed description of the disclosure, and the accompanying drawings.

What is claimed is:

1. A suspension device for a ground rover vehicle including a pair of front wheels, a pair of center wheels, and a pair of rear wheels provided on a vehicle body, the suspension device comprising:
main leaf springs disposed along a forward-backward direction of the vehicle body on both sides along a vehicle width direction of the vehicle body, the main leaf springs being pivotally connected to lower sides of the vehicle body, and to which the pair of front wheels and the pair of center wheels are connected; and
a sub-leaf spring disposed along the vehicle width direction at a rear of the vehicle body, fixed to a rear lower part of the vehicle body, and to which the pair of rear wheels are connected.

2. The suspension device of claim 1, further comprising:
a main damper connecting the main leaf springs and the vehicle body; and
a sub-damper connected to both sides of the sub-leaf spring and the vehicle body.

3. The suspension device of claim 1, further comprising
a pivot bush joint that is mounted on each of the main leaf springs and configured to engage the vehicle body.

4. The suspension device of claim 1, wherein:
each of the main leaf springs is U-shaped; and
the sub-leaf spring is straight.

5. The suspension device of claim 1, wherein each of the main leaf springs comprises:
a straight portion formed along the forward-backward direction of the vehicle body; and
a front bent portion and a rear bent portion extending outwardly from the front and rear ends of the straight portion toward an edge of the vehicle body along the vehicle width direction.

6. The suspension device of claim 5, wherein:
a pivot bush joint capable of engaging the vehicle body is mounted on the straight portion;
a front wheel of the pair of front wheels is installed on the front bent portion; and
a center wheel of the pair of center wheels is installed on the rear bent portion.

7. The suspension device of claim 1, wherein the sub-leaf spring comprises a straight leaf spring fixed to a spring mount portion provided on the vehicle body.

8. The suspension device of claim 7, wherein
the pair of rear wheels are each installed at ends of the straight leaf springs, which extend outward from an edge of the vehicle body along the vehicle width direction.

9. The suspension device of claim 5, further comprising:
a front steering knuckle assembly rotatably connected to the front bent portion;
a fixed knuckle assembly fixed to the rear bent portion; and
a rear steering knuckle assembly rotatably connected to both ends of the sub-leaf spring.

10. The suspension device of claim 9, further comprising:
a front steering actuator connected to the front steering knuckle assembly; and
a rear steering actuator connected to the rear steering knuckle assembly.

11. The suspension device of claim 9, wherein:
the pair of front wheels include mounted in-wheel motors, wherein a front wheel of the pair of front wheels is installed on the front steering knuckle assembly;
a center wheel of the pair of center wheels is installed on the fixed knuckle assembly; and
the pair of rear wheels include mounted in-wheel motors, wherein a rear wheel of the pair of rear wheels is installed on the rear steering knuckle assembly.

12. The suspension device of claim 9, wherein the front steering knuckle assembly comprises:
a front steering knuckle body;
a front steering shaft provided on the front steering knuckle body and rotatably connected to the front bent portion; and
front bearings connected to an upper part and a lower part of the front steering shaft with the front bent portion in between.

13. The suspension device of claim 9, wherein the rear steering knuckle assembly comprises:
a rear steering knuckle body;
a rear steering shaft provided on the rear steering knuckle body and rotatably connected to both ends of the sub-leaf spring; and
rear bearings connected to an upper part and a lower part of the rear steering shaft with the sub-leaf spring in between.

14. The suspension device of claim 2, wherein the main damper comprises
a main shock absorber hinge-connected to a damper bracket mounted on the main leaf springs and hinge-connected to a damper bracket mounted on the vehicle body.

15. The suspension device of claim 2, wherein the sub-damper comprises a sub-shock absorber hinge-connected to a damper bracket mounted on both sides of the sub-leaf spring and hinge-connected to a damper bracket mounted on the vehicle body.

16. The suspension device of claim 1, wherein the main leaf springs and the sub-leaf springs are made of plastic composite material or metal material.
